(19) United States
(12) Patent Application Publication
(10) Pub. No.: US 2012/0206297 A1
(43) Pub. Date: Aug. 16, 2012

(54) ADAPTIVE POSITIONING SIGNAL SEARCH STRATEGY FOR A MOBILE DEVICE

(75) Inventors: Jie Wu, San Diego, CA (US); Lalitaprasad V. Daita, San Jose, CA (US); Duong A. Hoang, San Diego, CA (US)

(73) Assignee: QUALCOMM Incorporated, San Diego, CA (US)

(21) Appl. No.: 13/326,181

(22) Filed: Dec. 14, 2011

Related U.S. Application Data
(60) Provisional application No. 61/423,899, filed on Dec. 16, 2010.

(51) Int. Cl. G01S 19/48

(52) U.S. Cl. 342/357.31

(57) ABSTRACT

Various techniques are provided which may be implemented in a mobile device to acquire a first positioning signal transmitted by a first transmitter of a first satellite in geostationary orbit, associate the first positioning signal with a coverage region to determine a rough position of the mobile device, and affect a positioning signal search strategy based, at least in part, on the rough position of the mobile device. The search strategy may identify at least one transmitter of at least one satellite in non-geostationary orbit that is estimated to be located in a position to transmit a second positioning signal within at least a portion of the coverage region, and which may be searched for by the mobile device. Such techniques may, for example, reduce a first time to a position fix in certain instances.

CLAIM OF PRIORITY UNDER 35 U.S.C. §119

This application claims priority under 35 USC 119 to U.S. Provisional Application Ser. No. 61/423,899, filed Dec. 16, 2010, and entitled, “ADAPTIVE SEARCH METHODS FOR REGIONAL SATELLITE SYSTEMS”, which is assigned to the assignee hereof and which is incorporated herein by reference.

### BACKGROUND

1. Field

The subject matter disclosed herein relates to electronic devices, and more particularly to methods, apparatuses and articles of manufacture for use in or by a mobile device to use and adapt a positioning signal search strategy while attempting to acquire positioning signals transmitted by transmitters onboard satellites of one or more satellite positioning systems (SPSs).

2. Information

The Global Positioning System (GPS) represents one type of Global Navigation Satellite System (GNSS), which along with other types of satellite positioning systems (SPS), such as Regional Navigation Satellite Systems (RNSS), provide or otherwise support signal-based position location capabilities (e.g., positioning functions) in mobile devices.

SPS receivers are provided within electronic devices to obtain positioning signals from various SPS transmitters, and based, at least in part, on the positioning signals determine pseudorange measurements for the distances that the positioning signals traveled between their respective SPS transmitters and the SPS receiver. By knowing a position location for each of the SPS transmitters at the time they transmitted their respective positioning signals and the pseudorange measurements, a mobile device may be able to estimate its relative position location. Typically, three or more different positioning signals are needed to determine a position fix.

However, under certain conditions a time to first fix may be extended as the SPS receiver in a mobile device actively searches for and attempts to acquire enough positioning signals to determine a position fix. For example, an SPS receiver that does not know its course or even a rough position location, may have to implement a positioning signal search strategy that accounts for an entire coverage region of an SPS. Accordingly, there remains a desire to reduce a time to first fix.

### SUMMARY

In accordance with certain aspects, a method may be implemented in a mobile device, which comprises: acquiring a first positioning signal transmitted by a first transmitter of a first satellite in geostationary orbit; associating the first positioning signal with a coverage region to determine a rough position of the mobile device; affecting a positioning signal search strategy based, at least in part, on the rough position of the mobile device, the search strategy identifying at least one transmitter of at least one satellite in non-geostationary orbit that is estimated to be located in a position to transmit a second positioning signal within at least a portion of the coverage region; and searching for at least the second positioning signal.

In accordance with certain other aspects, an apparatus may be provided for use in a mobile device, the apparatus may comprise: means for acquiring a first positioning signal transmitted by a first transmitter of a first satellite in geostationary orbit; means for associating the first positioning signal with a coverage region to determine a rough position of the mobile device; means for affecting a positioning signal search strategy based, at least in part, on the rough position of the mobile device, the search strategy identifying at least one transmitter of at least one satellite in non-geostationary orbit that is estimated to be located in a position to transmit a second positioning signal within at least a portion of the coverage region; and means for searching for at least the second positioning signal.

In accordance with still other aspects, a mobile device may be provided which comprises: one or more receivers; and one or more processing units to: obtain, via the one or more receivers, a first positioning signal transmitted by a first transmitter of a first satellite in geostationary orbit; associate the first positioning signal with a coverage region to determine a rough position of the mobile device; affect a positioning signal search strategy based, at least in part, on the rough position of the mobile device, the search strategy identifying at least one transmitter of at least one satellite in non-geostationary orbit that is estimated to be located in a position to transmit a second positioning signal within at least a portion of the coverage region; and search for at least the second positioning signal.

In accordance with yet another aspect, in article of manufacture may be provided for use with one or more mobile devices, the article of manufacture may comprise a non-transitory computer readable medium having stored thereon instructions executable by one or more processing units of the mobile device to: obtain, via one or more receivers, a first positioning signal transmitted by a first transmitter of a first satellite in geostationary orbit; associate the first positioning signal with a coverage region to determine a rough position of the mobile device; affect a positioning signal search strategy based, at least in part, on the rough position of the mobile device, the search strategy identifying at least one transmitter of at least one satellite in non-geostationary orbit that is estimated to be located in a position to transmit a second positioning signal within at least a portion of the coverage region; and initiate a search, via the one or more receivers, for at least the second positioning signal.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an environment in which a mobile device may make use of, and/or otherwise adapt in some manner, a positioning signal search strategy while attempting to acquire positioning signals transmitted by transmitters onboard satellites of one or more satellite positioning systems (SPSs), in accordance with an example implementation.

FIG. 2 is a schematic block diagram illustrating certain features of a computing device that may be provided in a form of a mobile device, and which may make use of, and/or otherwise adapt in some manner, a positioning signal search strategy while attempting to acquire positioning signals transmitted by transmitters onboard satellites of one or more SPSs, in accordance with an example implementation.

FIG. 3 is a flow diagram illustrating an example method that may be implemented in a mobile device to make use of, and/or otherwise adapt in some manner, a positioning signal search strategy while attempting to acquire positioning signals transmitted by transmitters onboard satellites of one or more SPSs, in accordance with an example implementation.

### DETAILED DESCRIPTION

Techniques are provided herein which may be implemented through various methods, apparatuses, and/or articles of manufacture for use in or by a mobile device to use and adapt a positioning signal search strategy while attempting to acquire positioning signals transmitted by transmitters onboard satellites of one or more satellite positioning systems (SPSs). For example, techniques provided herein may be implemented in a mobile device that is capable of searching for and acquiring positioning signals associated with one or more regional navigation satellite systems (RNSSs) and one or more global navigation satellite systems (GNSSs). For example, techniques provided herein may be implemented in a manner that reduces a time to first fix under certain conditions.

In accordance with certain example implementations, a mobile device may acquire a first positioning signal that is transmitted by a first transmitter of a first satellite in geostationary orbit. For example, a mobile device may use a special purpose receiver and/or a multiple purpose receiver to search for and acquire a positioning signal transmitted by a satellite in geostationary orbit that supports a RNSS and/or other like positioning service. The mobile device may associate the first positioning signal with a coverage region and as such determine a rough position of the mobile device, e.g. as being within such a coverage region. Thus for example, a mobile device may estimate its rough position to be within a coverage region of a particular RNSS based, at least in part, on acquiring a positioning signal transmitted by a RNSS transmitter onboard a satellite in geostationary orbit. The mobile device may then affect a positioning signal search strategy to search for and acquire positioning signals based, at least in part, on the rough position that has been determined. For example, a search strategy may identify one or more positioning signals that may be transmitted by one or more transmitters onboard one or more satellites in non-geostationary orbit. Thus, for example, a mobile device may affect such a search strategy to more effectively search for positioning signals that are estimated to be available for acquisition within the coverage region. For example, if a particular satellite in non-geostationary orbit is estimated to be located in a position to transmit a second positioning signal within at least a portion of the coverage region, then such a second positioning signal and/or its transmitter may be identified as a more likely candidate in a search strategy. For example, a positioning signal and/or transmitter may be identified as a more likely candidate in a search strategy by affecting a search order and/or other like list such that a search is conducted for the more likely candidate positioning signal sooner and/or more often than for other signals/transmitters.

As will be shown in certain examples herein, in certain instances a first satellite may operatively support and/or otherwise be arranged within a RNSS, and the at least one satellite in non-geostationary orbit may operatively support and/or otherwise be arranged within a GNSS.

In certain example implementations, a mobile device may further determine a first pseudorange measurement from the mobile device to the first transmitter based, at least in part, on the first positioning signal, and a second pseudorange measurement from the mobile device to the at least one satellite in non-geostationary orbit based, at least in part, on the second positioning signal, e.g. using known techniques. Thus, for example, a mobile device may estimate its location relative to some coordinate system based, at least in part, on the first and second pseudorange measurements.

In certain example implementations, a first transmitter may transmit multiple signal components, and the receiver within a mobile device may attempt to acquire such a first positioning signal by searching the multiple signal components in some particular order. For example, the mobile device may attempt to acquire such a first positioning signal by searching the multiple signal components in an order of known transmission power of the multiple signal components.

In certain example implementations, a positioning signal search strategy may be indicative of a plurality of signals transmitted by a plurality of satellites. In certain instances, a positioning signal search strategy may be indicative of pseudonoise codes corresponding to a plurality of signals/transmitters, for example. In certain example implementations, a plurality of satellites may comprise one or more satellites in geostationary orbit and one or more satellites in non-geostationary orbit. Thus, for example, a positioning signal search strategy may be indicative of a search order in which one or more satellites in geostationary orbit are interleaved with one or more satellites in non-geostationary orbit. Here, for example, a search order may be indicative of signals transmitted by two or more satellites in geostationary orbit (e.g., associated with two or more RNSS) which are interleaved or otherwise mixed in some manner within the search order with signals transmitted by two or more satellites in non-geostationary orbit (e.g., associated with one or more GNSS). By way of example, in certain implementations a search order may be generated, maintained, and/or affected, to search for candidate positioning signals based on a round-robin scheduling algorithm and/or the like.

In certain example implementations, a mobile device may obtain, generate, affect, and/or otherwise maintain a list of active RNSS transmitters and a global list of RNSS transmitters, and (e.g., according to a positioning signal search strategy) attempt to acquire signals transmitted by RNSS transmitters in the active list more frequently than RNSS transmitters not in the active list. In certain instances, the mobile device may, for example, in response to acquisition of a specific signal transmitted by a specific RNSS transmitter, add an RNSS transmitter to the active list that may not have previously been in the active list.

SPS such as a GNSS (e.g., the Global Positioning System (GPS), Galilleo, GLONASS, and the like) and/or a RNSS (e.g., WAAS, EGNOS, QZSS, and the like) rely on an ability of mobile device to search for and acquire positioning signals from transmitters onboard space vehicles (SVs), e.g., orbiting satellites. For each acquired positioning signal, a mobile device may determine a pseudorange measurement between the mobile device and the transmitter, e.g., based on time of flight, etc. With pseudorange measurements to a sufficient number of transmitters and knowledge of locations of the transmitters, a mobile device may estimate its location. For example, three pseudorange measurements may be sufficient to determine an estimated location (e.g., latitude and longitude, etc.) of a mobile device with regard to a map/coordinate system. Given a fourth pseudorange measurement, a mobile device may further be able to determine its estimated altitude, e.g. with respect to a map/coordinate system.

To provide for global coverage, the SVs supporting a GNSS tend to be placed into non-geostationary orbits. Hence, positioning signals (e.g., SPS signals) associated with a GNSS are usually not restricted to specific regions of the Earth (e.g., on the Earth's surface and regions above the surface). Using GNSS alone for obtaining a position fix may be computationally and time intensive if an accurate estimate of time or rough estimate of position is not known or available. As discussed herein, particular techniques may be used to determine a rough position by acquiring signals from one or more geostationary satellite paste transmitters, such as, in a RNSS (e.g., a regional satellite positioning system (RSPS), etc.) to obtain a course position before attempting to obtain an accurate position fix by acquiring SPS signals from one or more GNSS′.

For example, as mentioned previously, by acquiring a positioning signal transmitted by an RNSS SV a mobile device may determine its rough position as being within the coverage region of the RNSS SV. Once a mobile device has narrowed its position to such a rough position, then it may affect a positioning signal search strategy in some manner so as to more quickly search for positioning signals transmitted by other SVs (e.g., GNSS, and/or RNSS) that may be sufficiently located overhead to transmit their respective positioning signals by a line of sight to within at least a portion of the coverage region of the RNSS SV. In other words, a positioning search strategy may be affected to initiate earlier searching for positioning signals from overhead SVs that are likely to have coverage regions that may currently overlap at least in part, or that may soon overlap at least in part, of the coverage region of the RNSS SV.

A RNSS (e.g., WAAS, EGNOS, QZSS, etc.) typically deploys one or more SVs in a geostationary orbit (e.g., substantially synchronous with the Earth's rotation). Since SVs in geostationary orbit do not move relative to points on the globe, signal coverage of a particular RNSS is typically limited to fixed smaller geographic regions. In particular applications, an RNSS may transmit signals indicating anomalies for particular GNSS′ and a differential correction message for use in differential GPS processing. Positioning signals transmitted from an RNSS transmitter may also be modulated with a unique pseudonoise code for use in obtaining a pseudorange measurement which, in combination with pseudorange measurements obtained from a GNSS, may be used for obtaining a position fix.

In one particular implementation, the course position of a mobile device receiver may be unknown. Attempting to acquire positioning signals from GNSS transmitters under such a “cold start” state with no rough position or accurate estimate of an applicable “SPS time” may consume significant time and battery life. However, as previously mentioned, acquisition of a positioning signal transmitted by an RNSS in advance of obtaining a GNSS position fix may allow for at least rough position estimate. With a rough position, a positioning signal search strategy may be affected to avoid or possibly postpone searching for positioning signals from other RNSS transmitters, and in particular other RNSS transmitters whose coverage region does not overlap the rough position and/or fails to fall within some threshold distance from the rough position. Likewise, with a rough position, a positioning signal search strategy may be affected to avoid or possibly postpone searching for positioning signals from certain GNSS SVs, e.g., in particular a GNSS SVs whose current coverage region does not and will not soon overlap the rough position and/or pass within some threshold distance from the rough position. Hence, for example, the rough position provides a capability to affect a positioning signal search strategy to allow for earlier searches for candidate positioning signals transmitted from SVs whose coverage region may overlap the rough position and/or fall within some threshold distance from the rough position. It should be kept in mind that a threshold distance may vary depending on the positioning signal being searched for and/or other considerations relating to the mobile device and/or SPS transmitter. Similarly, when considering non-geostationary SVs, a mobile device may apply certain thresholds to SPS time based calculations in determining a location of orbiting SVs, e.g., to possibly account for the mobile device initially being out of synchronization with SPS time. Accordingly, subsequent activities based on an affected positioning signal search strategy leading to a position fix may be focused on RNSS transmitters having a coverage region including the rough position and GNSS transmitters which may be or are soon expected to be in view.

In particular implementations, attempts to acquire a positioning signal from an RNSS SV may include exhaustively correlating received signals with pseudonoise codes assigned to different transmitters until a correlation peak is detected. Any particular RNSS may include multiple satellite transmitters where each individual transmitter is assigned a unique pseudonoise code to modulate a signal transmitted from the transmitter. A particular pseudonoise code resulting in the correlation peak then identifies a particular satellite transmitter covering a specific region in which the receiver of the mobile device is located (or the mobile device's rough position). In one particular implementation, a positioning signal search strategy may initiate (e.g., via a search order) one or more receivers to attempt to acquire positioning signals (e.g., through correlation) transmitted from satellite transmitters in different RNSS in an interleaved fashion so that pseudonoise codes assigned to two different satellites from the same RNSS are not searched for consecutively. Here, for example, a round robin approach may search pseudonoise codes in the following order: WAAS1, EGNOS1, QZSS1, WAAS2, EGNOS2, QZSS2, . . .

In this fashion, an acquisition of an RNSS signal (which enables determination of a rough position) may occur more quickly and consuming less battery life than exhaustively searching pseudonoise codes assigned to transmitters in a first RNSS before searching any pseudonoise codes assigned to transmitters in a second RNSS.

In certain example implementations, a positioning signal search strategy may initiate (e.g., via a search order) one or more receivers to attempt to acquire positioning signals transmitted from satellite transmitters in different RNSS in an interleaved fashion along with positioning signals transmitted from satellite transmitters in one or more GNSS.

In certain example implementations, one or more receivers in a mobile device, may maintain a list of all known satellite transmitters in RNSS′ and a separate list of “active” satellite transmitters. Hence, at times, a positioning signal search strategy may indicate that positioning signals from satellite transmitters in the active list be searched more frequently than other RNSS satellite transmitters which are not in the active list. If a positioning signal transmitted from an RNSS satellite transmitter which is not on the active list is acquired and verified, that RNSS satellite transmitter may be placed on the active list.

In another implementation, an RNSS satellite transmitter may transmit multiple signals in the same frequency band (e.g., QZSS). In attempting to acquire a signal from such a satellite transmitter, a positioning signal search strategy may place earlier and/or more often search focus on the signal known to have the strongest signal power (e.g., L1C/A). Should such a positioning signal be acquired, then other signals (such as SAIF) may be tracked right away, if applicable to a positioning fix and/or other ongoing process of the mobile device.

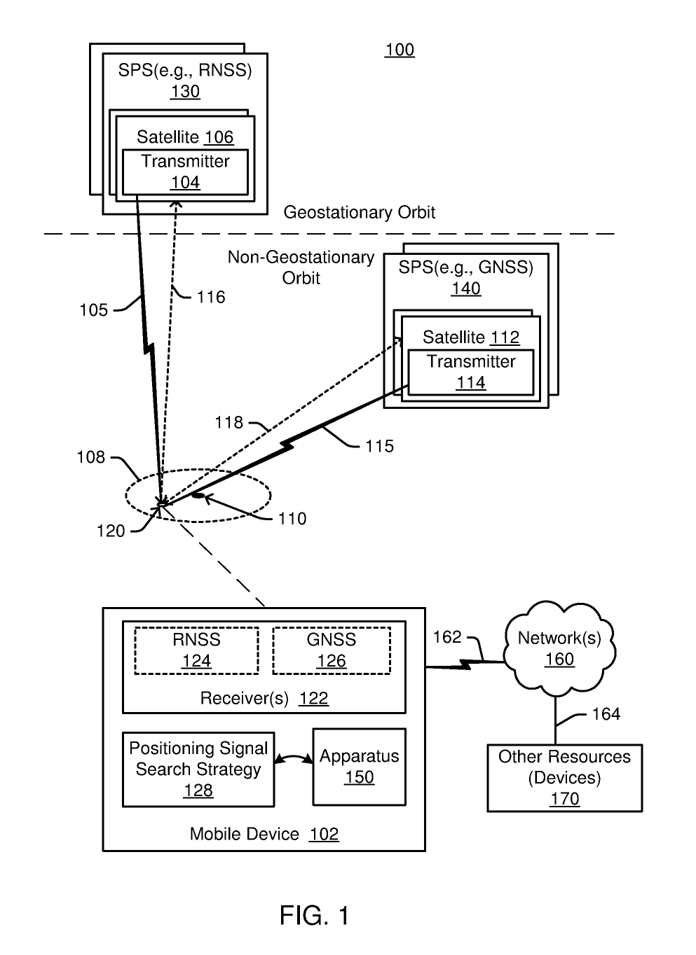

FIG. 1 is a schematic block diagram illustrating an environment 100 in which a mobile device 102 may make use of, and/or otherwise adapt in some manner, a positioning signal search strategy 128 while attempting to acquire positioning signals 105/115 transmitted by SPS SV based transmitters, in accordance with an example implementation.

Mobile device 102 is representative of any electronic device that may be carried and/or otherwise moved about such that its position may change from time to time. For example, mobile device 102 may comprise a portable computing device and/or portable communication device that may be carried by a person. For example, mobile device 102 may comprise a portable machine, a vehicle, a container, and/or some other device that may be fixed to a movable object whose position may change from time to time.

As illustrated in FIG. 1, an example mobile device 102 may comprise one or more receivers 122 for acquiring one or more positioning signals 105/115. In this example, receiver(s) 122 are illustrated as comprising at least one RNSS receiver 124 and at least one GNSS receiver 126. It should be recognized that in certain instances a single receiver may be provided which is capable of acquiring one or more positioning signals 105/115 from one or more transmitters supporting one or more SPS 130/140. In this example SPS 130 represents one or more RNSS, wherein at least one of the RNSS comprises a satellite 106 (e.g., SV) having at least one transmitter 104 which transmits positioning signal 105. SPS 140 represents one or more GNSS, wherein at least one of the GNSS comprises a satellite 112 (e.g., SV) having at least one transmitter 114 which transmits positioning signal 115.

As illustrated by the bisecting dashed line within FIG. 1, SPS 130 comprises satellites (SVs) that are placed in geostationary orbits, and SPS 140 comprises satellites(SVs) that are placed in non-geostationary orbits.

Further illustrated within FIG. 1 is a coverage region 108, which in this example has a non-limiting circular/oval shape. Coverage region 108 is intended to represent a coverage region, e.g. on a surface of the earth and/or at some altitude therefrom, for positioning signal 105 as transmitted by transmitter 104. Note that transmitter 104 is located on board satellite 106 which is in geostationary orbit. A mark (small oval) is at or near the center of coverage region 108 and may, in certain example instances, be associated with a rough position 110 of mobile device 102 by apparatus 150, e.g. in response to obtaining positioning signal 105 which may be acquired by receiver(s) 122 while mobile device 102 may be located with in coverage region 108. While a rough position of mobile device 102 may be assigned to a particular point in space within coverage region 108 in certain example implementations, in other example implementations a rough position may itself identify some region of space that may overlap all or part of coverage region 108. For example in certain implementations be rough position may comprise a particular point in space along with one or more threshold distance measurement values relating thereto which define some region of space.

In the example illustrated in FIG. 1, a mobile device 102 may have an estimated location at position 120 within coverage region 108. Accordingly, and by way of the illustrated example, a first pseudorange measurement 116 may be determined by mobile device 102 based on positioning signal 105. Here, for example first pseudorange measurement 116 may represent an estimated distance that positioning signal 105 traveled from satellite 112 to mobile device 102. Similarly, for example, a second pseudorange measurement 118 is illustrated between satellite 112 and a mobile device 102. Second pseudorange measurement 118 may, for example, be determined based, at least in part, on positioning signal 115.

Mobile device 102 may comprise, for example, an apparatus 150 that may affect positioning signal search strategy 128, e.g., with regard to the various techniques provided herein.

In certain instances, mobile device 102 may communicate with one or more other resources (devices) 170, e.g. via network(s) 160 over wireless communication link 162 and or wired communication link 164. By way of example, other resources 170 may provide information that may be of use to apparatus 150. Similarly, for example, mobile device 102 may provide information regarding positioning signal search strategy 128 and/or other aspects of the techniques provided herein to one or more other resources 170.

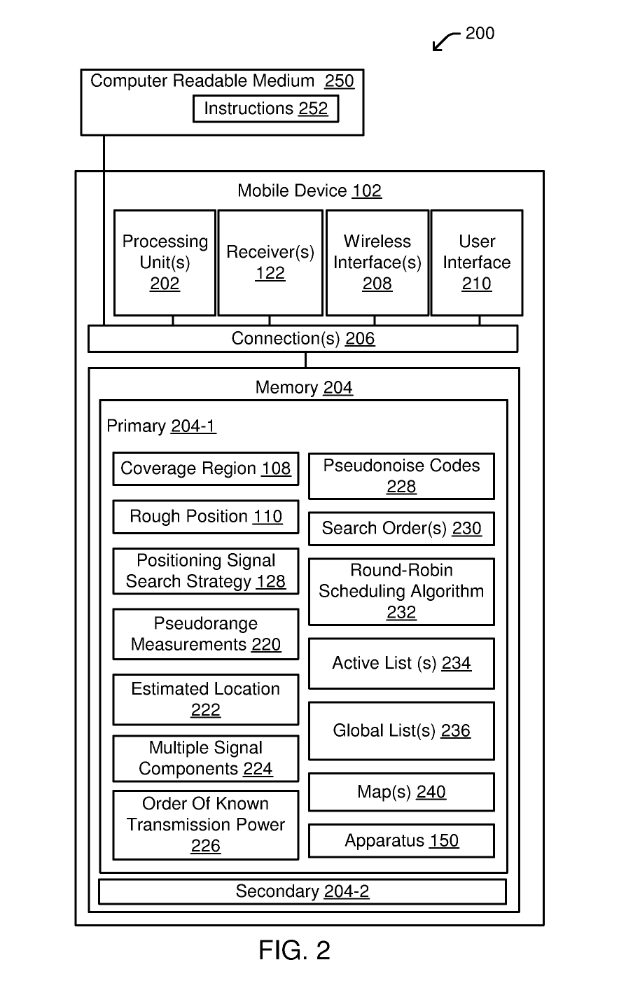

FIG. 2 is a schematic block diagram illustrating certain features of a computing device 200 that may be provided in a form of a mobile device 102, and which may make use of, and/or otherwise adapt in some manner, a positioning signal search strategy 128 while attempting to acquire positioning signals 105/115, in accordance with an example implementation.

As illustrated, computing platform 200 may comprise one or more processing units 202 to perform data processing (e.g., in accordance with the techniques provided herein) coupled to memory 204 via one or more connections 206. Processing unit(s) 202 may, for example, be implemented in hardware or a combination of hardware and software. Processing unit(s) 202 may, for example, be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, and the like, or any combination thereof.

Memory 204 may be representative of any data storage mechanism. Memory 204 may include, for example, a primary memory 204-1 and/or a secondary memory 204-2. Primary memory 204-1 may comprise, for example, a random access memory, read only memory, etc. While illustrated in this example as being separate from the processing units, it should be understood that all or part of a primary memory may be provided within or otherwise co-located/coupled with processing unit(s) 202, or other like circuitry within mobile device 102. Secondary memory 204-2 may comprise, for example, the same or similar type of memory as primary memory and/or one or more data storage devices or systems, such as, for example, a disk drive, an optical disc drive, a tape drive, a solid state memory drive, etc. In certain implementations, secondary memory may be operatively receptive of, or otherwise configurable to couple to, a (non-transitory) computer readable medium 250. Memory 204 and/or computer readable medium 250 may comprise computer-implementable instructions 252 for certain example techniques as provided herein.

As illustrated in FIG. 2, at various times, memory 204 may store certain signals representing data and/or computer-implementable instructions for certain example techniques as provided herein. For example, memory 204 may store data and/or computer-implementable instructions for apparatus 150. By way of example, memory 204 may at various times store representative data for information representing all or part of one or more coverage regions 108, one or more rough positions 110, one or more positioning signal search strategies 128, one or more pseudorange measurements 220, one or more estimated locations 222, multiple signal components 224, an order of known transmission power 226, one or more pseudonoise codes 228, one or more search order(s) 230, a round-robin scheduling algorithm 232 and/or the like, one or more lists of active transmitters 234, one or more global lists of transmitters 236, one or more electronically encoded maps 240, and/or the like or some combination thereof.

As shown, mobile device 102 may, for example, comprise one or more wireless interface(s) 208. Wireless interface(s) 208 may, for example, provide a capability to receive and/or transmit wired and/or wireless signals, e.g., to communicate via network(s) 160 (FIG. 1). Wireless interface 208 may be comprised of one or more interfaces possibly including but not limited to interfaces for wide area networks (WAN) such as GSM, UMTS, CDMA, LTE, WCDMA and CDMA 2000 and interfaces for personal area networks (PAN) such as WiFi and Bluetooth. It is also understood that there may be multiple wireless interfaces 208 that may be used simultaneously or individually. Wireless interface 208, may in certain implementations also concurrently and/or alternatively act as a receiver device (and/or transceiver device). In certain example implementations, wireless interface 208 may also be representative of one or more wired network interfaces.

As shown, mobile device 102, for example, may comprise one or more receiver(s) 122, which may acquire positioning signals 105/115 (FIG. 1), and provide one or more electrical signals representing such acquired positioning signals to processing units 202 and/or memory 204, for example. In certain instances, all or part of a positioning engine or other like capability may be provided by receiver(s) 122 and used to obtain a positioning fix, and/or other like positioning and/or navigation information relating to mobile device 102.

As shown, mobile device 102 may comprise one or more user interfaces 210. For example user interface 210 may be representative of one or more user input and/or user output devices. Thus, for example, user interface 210 may comprise a keypad, a touch screen, various buttons, various indicators, a display screen, a speaker, a microphone, a projector, a camera, etc. a position fix may, for example, be presented to a user via one or more user interfaces 210. In certain example instances, a position fix may be presented along with and/or with reference to various information in map 240, and/or the like.

As previously noted, mobile device 102 may be representative of any electronic device that may be moved about within environment 100. For example, mobile device 102 may comprise a hand-held computing and/or communication device, such as, a mobile telephone, a smart phone, a lap top computer, a tablet computer, a positioning/navigation device, and /or the like. In certain example implementations, mobile device 102 may be part of a circuit board, an electronic chip, etc. in still other implementations, mobile device 102 may comprise all or part of the machine and/or other object that may be moved from one position to another within environment 100, e.g. by a person and/or some other mechanized device.

It should be understood that mobile device 102 may also or alternatively comprise one or more other circuits, mechanisms, etc., (not shown) that may be of use in performing one or more other functions or capabilities, and/or supportive of certain example techniques as provided herein.

Mobile device 102 may, for example, be enabled (e.g., via one or more wireless interfaces 208) for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMAX, Ultra Mobile Broadband (UMB), and/or the like.

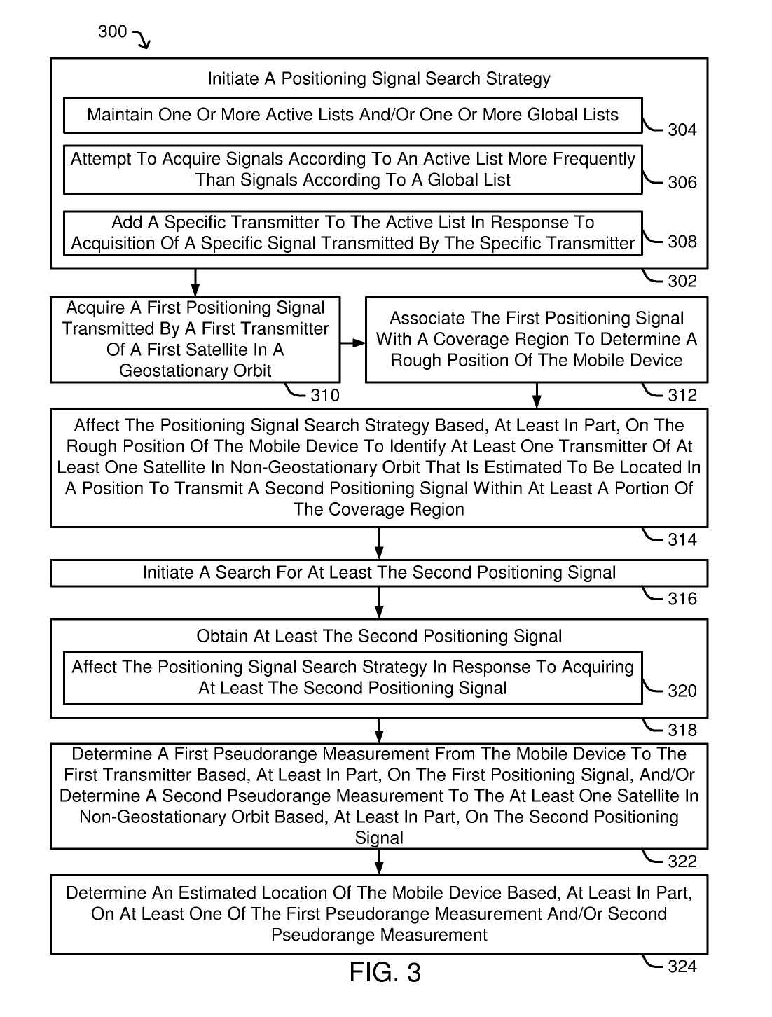

Attention is drawn next to FIG. 3, which is a flow diagram illustrating an example method or process 300 that may be implemented in a mobile device 102 to make use of, and/or otherwise adapt in some manner, a positioning signal search strategy 128 while attempting to acquire various positioning signals, in accordance with an example implementation.

At example block 302, a positioning signal search strategy may be initiated. For example, a positioning signal search strategy may indicate a search order that may be followed while attempting to acquire an initial positioning signal. In certain instances, a positioning signal search strategy may include one or more RNSS transmitted positioning signals which if acquired may be used to estimate a rough position of the mobile device. In certain instances, for example at block 304, a list of active transmitters (an active list) and a global list of transmitters may be maintained. For example, a list of active transmitters may indicate a plurality of RNSS positioning signals (and/or applicable RNSS SVs, etc.) that may be searched for with higher confidence level due to their usage history and/or some other aspect previously identified, then those indicated in a global list of transmitters. A list of active transmitters may relate to one or more RNSS. In certain example implementations, a global list of transmitters may comprise a null set. At example block 306, in certain instances an attempt to may be made to acquire signals transmitted by transmitters in the active list more frequently than transmitters not in the active list. At example block 308, a specific transmitter may be added to the active list in response to acquisition of a specific signal transmitted by the specific transmitter. In certain instances a positioning signal search strategy may comprise a search order wherein positioning signals for different RNSS are indicated in a mixed or otherwise interleaved manner. While the above examples pointed out that a positioning signal search strategy may initially indicate that certain RNSS positioning signals be searched for, it should be understood that in certain instances a positioning signal search strategy may further indicate that certain GNSS positioning signals be searched for.

One example type of RNSS is satellite-based augmentation system (SBAS). SBAS has a provision for using a total of thirty nine (39) different pseudorandom noise (PRN) codes , e.g. numbered from one hundred twenty (120) to one hundred fifty eight (158), to transmit signals. However, at the time of this writing, less than half of the thirty nine PRN codes are actually being used. Moreover, such usage may actually change over time. Such SBAS operational information is widely available, and hence is not repeated herein.

With this in mind, it should be understood that a manufacturer of a mobile device and/or other entity may generate and store or otherwise provide within a mobile device those PRN codes that may, for example, be currently being active for a particular RNSS, such as SBAS, etc. Hence, for example, information about currently active SVs/signals may be provided in an active list and information about currently in inactive SVs/signals may be provided in a global list. By way of a non-limiting example, an active list corresponding to SBAS may indicate that certain SVs/signals are active (e.g., as of this writing, corresponding to PRNs: 120-122, 124, 126-131, 133-138, 158), and a global list corresponding to SBAS may indicate that the remaining SVs/signals are inactive (e.g., as of this writing, corresponding to PRNs: 123, 125, 132, 139-157).

However, as mentioned, in certain RNSS the number of and/or particular SVs/signals that are active or inactive may change from time to time. As such, in accordance with certain aspects of the present description, a mobile device may maintain one or more active lists and/or one or more global lists based, at least in part, on signal related information obtained via the adaptive signal search techniques provided herein.

By way of example, for SBAS a mobile device may, at times and/or over a period of time, search for signals using all thirty nine PRNs (e.g., using the PRNs in both the active and global lists). As such, if there is a change in SBAS with regard to active/inactive SVs/signals being used the mobile device may be able to affect the active global lists accordingly.

Thus, for example with regard to block 304, in certain example instances, it may be beneficial for a mobile device to maintain one or more active lists and/or one or more global lists in a nonvolatile memory. In certain example instances, it may be beneficial for a mobile device to maintain one or more active lists and/or one or more global lists in a manner such that an SV/signal having a particular PRN may be removed from an active list if the mobile device has been unable to receive the signal for a certain period time and/or after certain times at one or more specific locations wherein such a signal would likely have been received if transmitted, e.g., while the mobile device is estimated to be within an applicable coverage region and the environment presents appropriate signaling conditions which would likely lead to the signal being received had been transmitted. In certain example instances it may be beneficial for a mobile device to maintain one or more active lists and/or one or more global lists which may be affected (e.g. updated, etc.), based, at least in part, on some form of assistance information that may be obtained by the mobile device via wireless or wired communication links from one or more other devices. In certain example instances it may be beneficial for a mobile device to maintain one or more active lists and/or one or more global lists by reprogramming and/or otherwise affecting instructions and/or data stored within a memory of a mobile device. Such techniques may be performed from time to time in an automated manner (e.g., according to a schedule, in response to particular event and/or message, etc.). Such techniques may be performed from time to time in a less automated manner e.g., one which may consider or otherwise make use of information obtained from a user of the mobile device via some user interface.

At example block 310, a first positioning signal transmitted by a first transmitter of a first satellite in a geostationary orbit may be acquired. Here for example the first satellite may comprise a particular RNSS SV. At example block 312, the first positioning signal may be associated with a coverage region and/or otherwise used to determine a rough position of the mobile device.

At example block 314, the positioning signal search strategy may be affected in some manner based, at least in part, on the rough position of the mobile device. A positioning signal search strategy may, for example, identify at least one transmitter of at least one satellite in non-geostationary orbit that is estimated to be located in a position to transmit a second positioning signal within at least a portion of the coverage region.

At example block 316, in accordance with the positioning signal search strategy, a search may be initiated for at least the second positioning signal. At example block 318, at least the second positioning signal may be obtained (e.g. acquired by a receiver and one or more electrical signals representing the second positioning signal made available to one or more processing units, and/or the like). In certain instances, at block 320, the positioning signal search strategy may be further affected in response to acquiring at least the second positioning signal. For example, in response to acquiring at least the second positioning signal, a mobile device may be able to further refine its estimated rough position which may allow for some adjustments and/or pruning of a search list and/or other information within the positioning signal search strategy.

At example block 322, a first pseudorange measurement from the mobile device to the first transmitter may be determined based, at least in part, on the first positioning signal, and/or a second pseudorange measurement to the at least one satellite in non-geostationary orbit may be determined based, at least in part, on the second positioning signal. At example block 324, an estimated location of the mobile device may be determined based, at least in part, on at least one of the first pseudorange measurement and/or second pseudorange measurement.

As can be appreciated by the example techniques provided herein, a mobile device 102 (FIG. 1) may, under certain circumstances, utilize the knowledge that a geostationary satellite based transmitter only has limited coverage region, to likely improve positioning signal search efficiency and possibly overall system performance. By way of further example, should a mobile device already know its rough position or coarse position then it may already have enough information to affect the positioning signal search strategy accordingly to avoid searching for the satellite systems whose coverage region does not overlap the coarse position. However, if such rough or coarse position are unknown and the mobile devices position uncertainty is essentially the whole Earth, then apparatus 150 (FIG. 1) may be used to initiate and possibly adapt a positioning signal search strategy which may search for and obtain a positioning signal for a satellite in a geostationary orbit which may then be used to reduce the position uncertainty of the mobile device, e.g. by estimating that a rough position of the mobile device is within a coverage region of the applicable satellite in geostationary orbit. Apparatus 150 may then affect the positioning signal search strategy based, at least in part, on the rough position. For example, the positioning signal search strategy may comprise a search list that may be affected to remove one or more positioning signals transmitted by one or more RNSS SVs and/or possibly certain GNSS SVs. Thus, in certain instances, apparatus 150 may allow for mobile device 102 to determine a position fix in an efficient manner.

Reference throughout this specification to “one example”, “an example”, “certain examples”, or “example implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

The methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information (e.g., as representative data). It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method comprising, at a mobile device:
acquiring a first positioning signal transmitted by a first transmitter of a first satellite in geostationary orbit;
associating said first positioning signal with a coverage region to determine a rough position of said mobile device;
affecting a positioning signal search strategy based, at least in part, on said rough position of said mobile device, said search strategy identifying at least one transmitter of at least one satellite in non-geostationary orbit that is estimated to be located in a position to transmit a second positioning signal within at least a portion of said coverage region; and
searching for at least said second positioning signal.

2. The method of claim 1, wherein said first satellite supports a regional navigation satellite system (RNSS) and said at least one satellite in non-geostationary orbit supports a global navigation satellite system (GNSS).

3. The method of claim 1, and further comprising:
determining a first pseudorange measurement from said mobile device to said first transmitter based, at least in part, on said first positioning signal;
determining a second pseudorange measurement from said mobile device to said at least one satellite in non-geostationary orbit based, at least in part, on said second positioning signal; and
estimating a location of said mobile device based, at least in part, on said first and second pseudorange measurements.

4. The method of claim 1, wherein said first transmitter transmits multiple signal components, and wherein acquiring said first positioning signal comprises searching said multiple signal components in an order of known transmission power of said multiple signal components.

5. The method of claim 1, wherein said positioning signal search strategy is indicative of a plurality of signals transmitted by a plurality of satellites.

6. The method of claim 5, wherein said positioning signal search strategy is indicative of pseudonoise codes corresponding to said plurality of signals.

7. The method of claim 5, wherein said plurality of satellites comprises at least one satellite in geostationary orbit and said at least one satellite in non-geostationary orbit.

8. The method of claim 7, wherein said positioning signal search strategy is indicative of a search order in which one or more satellites in geostationary orbit are interleaved with one or more satellites in non-geostationary orbit.

9. The method of claim 8, wherein two or more satellites in geostationary orbit associated with two or more RNSS are interleaved with two or more satellites in non-geostationary orbit associated with one or more GNSS within said search order.

10. The method of claim 9, wherein said two or more satellites in geostationary orbit associated with two or more RNSS are interleaved with two or more satellites in non-geostationary orbit associated with one or more GNSS within said search order based, at least in part, on a round-robin scheduling algorithm.

11. The method of claim 1, wherein said positioning signal search strategy is indicative of a search order, and wherein affecting said positioning signal search strategy comprises changing said search order.

12. The method of claim 11, and further comprising, at said mobile device:
further affecting said positioning signal search strategy in response to acquiring at least said second positioning signal.

13. The method of claim 1, wherein acquiring said first positioning signal further comprises:
maintaining an active list of RNSS transmitters and a global list of RNSS transmitters; and
attempting to acquire signals transmitted by RNSS transmitters in said active list more frequently than RNSS transmitters in said global list.

14. The method of claim 13, and further comprising, at said mobile device: affecting at least one of: said active list; or said global list based, at least in part, in response to at least one of: acquiring a specific signal; failing to acquire a particular signal; obtaining assistance data; identifying an occurrence of an event; receiving a message; or obtaining user input.

15. The method of claim 13, wherein at least one of: said active list; or said global list is maintained in a nonvolatile memory within said mobile device.

16. An apparatus for use in a mobile device, the apparatus comprising:
means for acquiring a first positioning signal transmitted by a first transmitter of a first satellite in geostationary orbit;
means for associating said first positioning signal with a coverage region to determine a rough position of said mobile device;
means for affecting a positioning signal search strategy based, at least in part, on said rough position of said mobile device, said search strategy identifying at least one transmitter of at least one satellite in non-geostationary orbit that is estimated to be located in a position to transmit a second positioning signal within at least a portion of said coverage region; and
means for searching for at least said second positioning signal.

17. The apparatus of claim 16, wherein said first satellite supports a regional navigation satellite system (RNSS) and said at least one satellite in non-geostationary orbit supports a global navigation satellite system (GNSS).

18. The apparatus of claim 16, and further comprising:
means for determining a first pseudorange measurement from said mobile device to said first transmitter based, at least in part, on said first positioning signal;
means for determining a second pseudorange measurement from said mobile device to said at least one satellite in non-geostationary orbit based, at least in part, on said second positioning signal; and
means for estimating a location of said mobile device based, at least in part, on said first and second pseudorange measurements.

19. The apparatus of claim 16, wherein said first transmitter transmits multiple signal components, and wherein said means for acquiring said first positioning signal comprises means for searching said multiple signal components in an order of known transmission power of said multiple signal components.

20. The apparatus of claim 16, wherein said positioning signal search strategy is indicative of a plurality of signals transmitted by a plurality of satellites.

21. The apparatus of claim 20, wherein said positioning signal search strategy is indicative of pseudonoise codes corresponding to said plurality of signals.

22. The apparatus of claim 20, wherein said plurality of satellites comprises at least one satellite in geostationary orbit and said at least one satellite in non-geostationary orbit.

23. The apparatus of claim 22, wherein said positioning signal search strategy is indicative of a search order in which one or more satellites in geostationary orbit are interleaved with one or more satellites in non-geostationary orbit.

24. The apparatus of claim 23, wherein two or more satellites in geostationary orbit associated with two or more RNSS are interleaved with two or more satellites in non-geostationary orbit associated with one or more GNSS within said search order.

25. The apparatus of claim 24, wherein said two or more satellites in geostationary orbit associated with two or more RNSS are interleaved with two or more satellites in non-geostationary orbit associated with one or more GNSS within said search order based, at least in part, on a round-robin scheduling algorithm.

26. The apparatus of claim 16, wherein said positioning signal search strategy is indicative of a search order, and wherein said means for affecting said positioning signal search strategy comprises means for changing said search order.

27. The apparatus of claim 26, and further comprising:
means for further affecting said positioning signal search strategy in response to acquiring at least said second positioning signal.

28. The apparatus of claim 16, and further comprising:
means for maintaining an active list of RNSS transmitters and a global list of RNSS transmitters; and
wherein said means for acquiring said first positioning signal comprises means for attempting to acquire signals transmitted by RNSS transmitters in said active list more frequently than RNSS transmitters in said global list.

29. The apparatus of claim 28, and further comprising:
means for affecting at least one of: said active list; or said global list based, at least in part, in response to at least one of: a specific signal being acquired; a particular signal not being acquired; assistance data being obtained;
an event having occurred; a message being received; or certain user input being obtained.

30. A mobile device comprising:
one or more receivers; and
one or more processing units to:
obtain, via said one or more receivers, a first positioning signal transmitted by a first transmitter of a first satellite in geostationary orbit;
associate said first positioning signal with a coverage region to determine a rough position of said mobile device;
affect a positioning signal search strategy based, at least in part, on said rough position of said mobile device, said search strategy identifying at least one transmitter of at least one satellite in non-geostationary orbit that is estimated to be located in a position to transmit a second positioning signal within at least a portion of said coverage region; and
search for at least said second positioning signal.

31. The mobile device of claim 30, wherein said first satellite supports a regional navigation satellite system (RNSS) and said at least one satellite in non-geostationary orbit supports a global navigation satellite system (GNSS).

32. The mobile device of claim 30, said one or more processing units to further:
obtain, via said one or more receivers, said second positioning signal;
determine a first pseudorange measurement from said mobile device to said first transmitter based, at least in part, on said first positioning signal;
determine a second pseudorange measurement from said mobile device to said at least one satellite in non-geostationary orbit based, at least in part, on said second positioning signal; and
estimate a location of said mobile device based, at least in part, on said first and second pseudorange measurements.

33. The mobile device of claim 30, wherein said first transmitter transmits multiple signal components, and wherein said one or more receivers acquires said first positioning signal by searching said multiple signal components in an order of known transmission power of said multiple signal components.

34. The mobile device of claim 30, wherein said positioning signal search strategy is indicative of a plurality of signals transmitted by a plurality of satellites.

35. The mobile device of claim 34, wherein said positioning signal search strategy is indicative of pseudonoise codes corresponding to said plurality of signals.

36. The mobile device of claim 34, wherein said plurality of satellites comprises at least one satellite in geostationary orbit and said at least one satellite in non-geostationary orbit.

37. The mobile device of claim 36, wherein said positioning signal search strategy is indicative of a search order in which one or more satellites in geostationary orbit are interleaved with one or more satellites in non-geostationary orbit.

38. The mobile device of claim 37, wherein, within said search order, two or more satellites in geostationary orbit associated with two or more RNSS are interleaved with two or more satellites in non-geostationary orbit associated with one or more GNSS.

39. The mobile device of claim 38, wherein said two or more satellites in geostationary orbit associated with two or more RNSS are interleaved with two or more satellites in non-geostationary orbit associated with one or more GNSS based, at least in part, on a round-robin scheduling algorithm.

40. The mobile device of claim 30, wherein said positioning signal search strategy is indicative of a search order, and wherein said one or more processing units affect said positioning signal search strategy by changing said search order.

41. The mobile device of claim 40, said one or more processing units to further:
affect said positioning signal search strategy in response to obtaining, via said one or more receivers, at least said second positioning signal.

42. The mobile device of claim 30, said one or more processing units to further:
maintain an active list of RNSS transmitters and a global list of RNSS transmitters; and
attempt to obtain, via said one or more receivers, one or more signals transmitted by RNSS transmitters in said active list more frequently than RNSS transmitters in said global list.

43. The mobile device of claim 42, said one or more processing units to further:
affect at least one of: said active list; or said global list based, at least in part, in response to at least one of: a specific signal being acquired; a particular signal not being acquired; assistance data being obtained; an event having occurred; a message being received; or certain user input being obtained.

44. The mobile device of claim 42, and further comprising:
nonvolatile memory; and
said one or more processing units to further obtain, from said nonvolatile memory, at least a portion of at least one of: said active list; or said global list.

45. The mobile device of claim 30, wherein said one or more receivers comprise at least one RNSS signal receiver and at least one GNSS signal receiver.

46. An article for use by a mobile device, the article comprising:
a non-transitory computer readable medium having stored thereon instructions executable by one or more processing units of said mobile device to:
obtain, via one or more receivers, a first positioning signal transmitted by a first transmitter of a first satellite in geostationary orbit;
associate said first positioning signal with a coverage region to determine a rough position of said mobile device;
affect a positioning signal search strategy based, at least in part, on said rough position of said mobile device, said search strategy identifying at least one transmitter of at least one satellite in non-geostationary orbit that is estimated to be located in a position to transmit a second positioning signal within at least a portion of said coverage region; and
initiate a search, via said one or more receivers, for at least said second positioning signal.

47. The article of claim 46, wherein said first satellite supports a regional navigation satellite system (RNSS) and said at least one satellite in non-geostationary orbit supports a global navigation satellite system (GNSS).

48. The article of claim 4648, said instructions being further executable by said one or more processing units to:
determine a first pseudorange measurement from said mobile device to said first transmitter based, at least in part, on said first positioning signal;
determine a second pseudorange measurement from said mobile device to said at least one satellite in non-geostationary orbit based, at least in part, on said second positioning signal; and
estimate a location of said mobile device based, at least in part, on said first and second pseudorange measurements.

49. The article of claim 46, wherein said first transmitter transmits multiple signal components, and wherein acquiring said first positioning signal comprises searching said multiple signal components in an order of known transmission power of said multiple signal components.

50. The article of claim 46, wherein said positioning signal search strategy is indicative of a plurality of signals transmitted by a plurality of satellites.

51. The article of claim 50, wherein said positioning signal search strategy is indicative of pseudonoise codes corresponding to said plurality of signals.

52. The article of claim 50, wherein said plurality of satellites comprises at least one satellite in geostationary orbit and said at least one satellite in non-geostationary orbit.

53. The article of claim 52, wherein said positioning signal search strategy is indicative of a search order in which one or more satellites in geostationary orbit are interleaved with one or more satellites in non-geostationary orbit.

54. The article of claim 53, wherein two or more satellites in geostationary orbit associated with two or more RNSS are interleaved with two or more satellites in non-geostationary orbit associated with one or more GNSS within said search order.

55. The article of claim 54, wherein said two or more satellites in geostationary orbit associated with two or more RNSS are interleaved with two or more satellites in non-geostationary orbit associated with one or more GNSS within said search order based, at least in part, on a round-robin scheduling algorithm.

56. The article of claim 46, wherein said positioning signal search strategy is indicative of a search order, and wherein affecting said positioning signal search strategy comprises changing said search order.

57. The article of claim 56, said instructions being further executable by said one or more processing units to:
affect said positioning signal search strategy in response to acquiring at least said second positioning signal.

58. The article of claim 46, said instructions being further executable by said one or more processing units to:
maintain an active list of RNSS transmitters and a global list of RNSS transmitters; and
attempt to obtain, via said one or more receivers, signals transmitted by RNSS transmitters in said active list more frequently than RNSS transmitters in said global list.

59. The article of claim 58, said instructions being further executable by said one or more processing units to:
affect at least one of: said active list; or said global list based, at least in part, in response to at least one of: a specific signal being acquired; a particular signal not being acquired; assistance data being obtained; an event having occurred; a message being received; or certain user input being obtained.
